(19) United States
(12) Patent Application Publication
(10) Pub. No.: US 2005/0062294 A1
(43) Pub. Date: Mar. 24, 2005

(54) Locking device for a ceiling mounted movie player

(76) Inventor: Tai-Hsiung Wu, Taoyuan (TW)

Correspondence Address: Jackson Walker L.L.P., Suite 2100, 112 E. Pecan Street, San Antonio, TX, 78205, US

(21) Appl. No.: 10/669,964

(22) Filed: Sep. 24, 2003

(51) Int. Cl. E05C 1/02

(52) U.S. Cl. 292/177

(57) ABSTRACT

A locking device for a ceiling mounted movie player includes a mounting plate having multiple L-shaped legs and a base having multiple holes corresponding to the L-shaped legs. After the L-shaped legs are extended into the corresponding holes, relative movement of the mounting plate to the base is able to secure engagement between the mounting plate and the base.

### BACKGROUND OF THE INVENTION

1. Field of the Invention

The present invention relates to locking device, and more particularly to a locking device for a ceiling mounted movie player.

2. Description of Related Art

Ceiling mounted movie players are becoming more and more popular with vehicle owners as they can provide entertainment and fun any time when the passengers feel like relaxing. Therefore, numerous kinds of ceiling mounted movie players have been introduced to the market and each one of them has a different locking structure to fix the movie player onto the ceiling of the vehicle. Normally, the most common way to mount the movie player onto the vehicle ceiling involves only riveting. That is, the frame to hold the movie player is riveted to the vehicle ceiling so that after the movie player is mounted onto the vehicle ceiling, the movie player can not be removed from the vehicle ceiling unless special tools and skills are employed. This is especially troublesome when the movie player malfunctions and has to be removed for repair. To overcome the shortcomings, the present invention tends to provide an improved locking device to mitigate the aforementioned problems.

### SUMMARY OF THE INVENTION

The primary objective of the present invention is to provide an improved locking device for a ceiling mounted movie player to facilitate the removal of the movie player from the vehicle ceiling.

To accomplish the foregoing objective, the locking device includes a mounting plate for receiving therein a movie player and a base adapted to be securely mounted on a vehicle ceiling. The base has multiple pairs of holes defined along opposite sides of the base and the mounting plate has multiple pairs of L-shaped legs formed on opposite sides of the mounting plate to correspond to the multiple pairs of holes of the base so that when the L-shaped legs are inserted into the holes of the base, movement of the mounting plate allows the L-shaped legs to securely clamp the base so that the mounting plate is securely engaged with the base and thus the movie player is secured to the vehicle ceiling.

Because the securing of the mounting plate having therein the movie player on the base involves only a simple movement of the mounting plate, assembly and disassembly of the mounting plate is easy.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the locking device of the present invention;

FIG. 2 is a bottom plan view of the locking device before initiation of a locking process between the mounting plate and the base;

FIG. 3 is a bottom plan view of the locking device after each of the L-shaped legs is securely engaged with a periphery of a corresponding one of the holes in the base; and

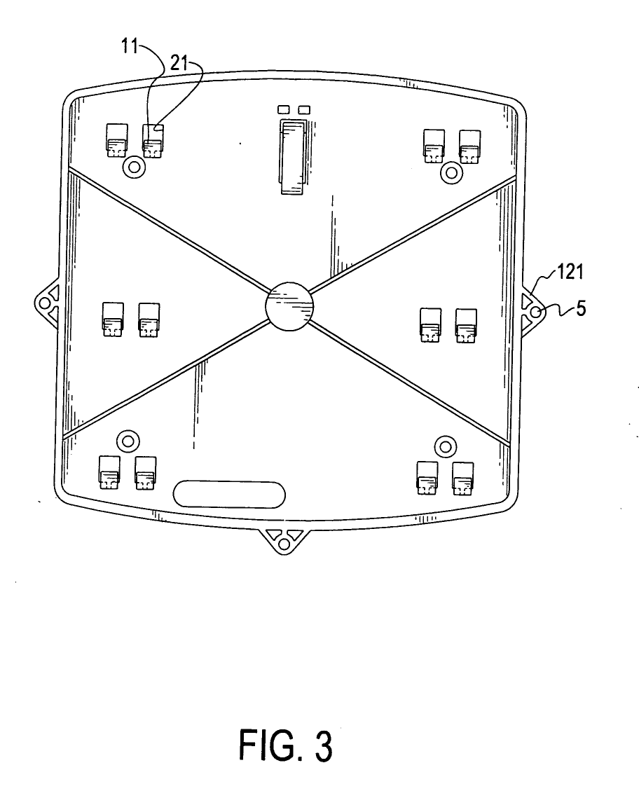

FIG. 4 is a schematic view showing the application of the present invention to support a ceiling display.

### DETAILED DESCRIPTION OF THE PREFERRED EMBODIMENT

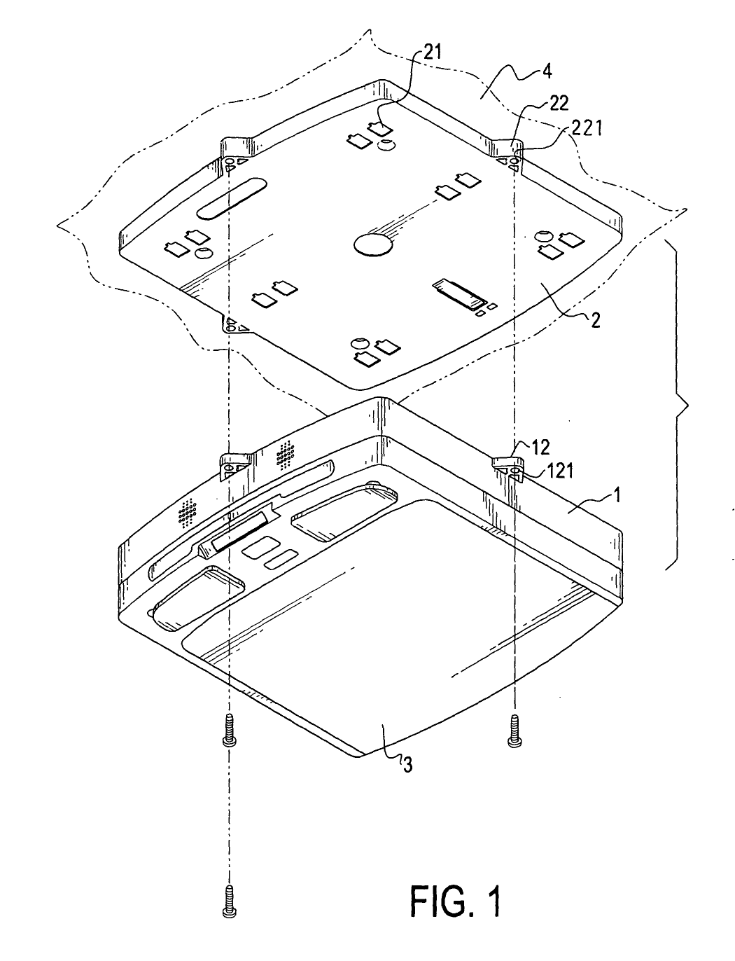

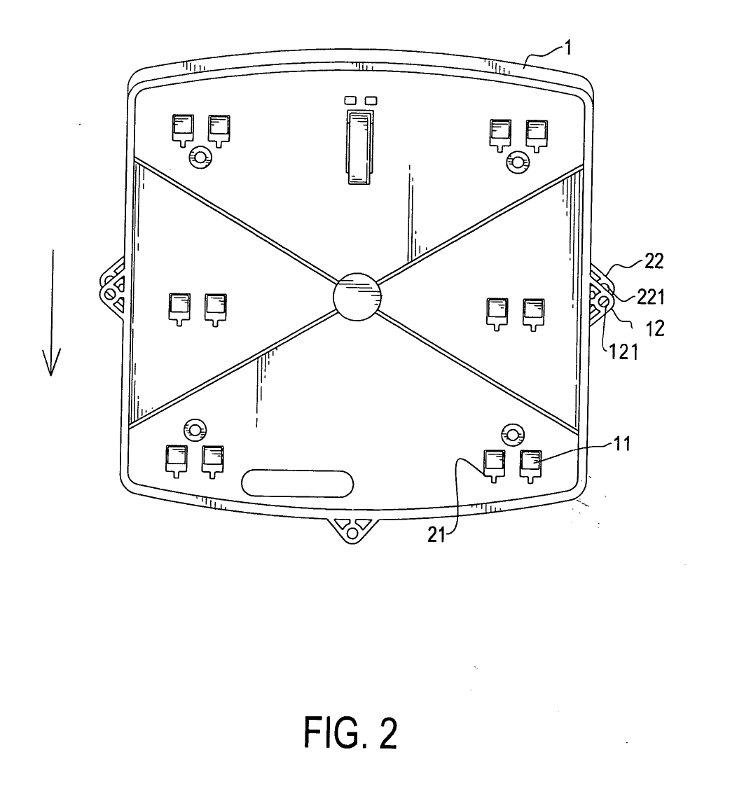

With reference to FIG. 1, the locking device in accordance with the present invention includes a mounting plate (1) for pivotally receiving therein a movie player (3) and a base (2) adapted to securely engage with a vehicle ceiling (4). With reference to FIG. 2, the mounting plate (1) has multiple pairs of L-shaped legs (11) formed opposite sides of a face of the mounting plate (1) and first ears (12) respectively formed on a peripheral side face of the mounting plate (1) and having a first hole (121) defined therethrough. The base (2) has multiple pairs of holes (21) oppositely defined along a side of the base (2) to correspond to the L-shaped legs (11) and multiple second ears (22) respectively formed on a peripheral side face of the base (2) and having a second hole (221) corresponding to the first hole (121).

When the mounting plate (1) is to be engaged with the base (2), the L-shaped legs (11) are first extended into the holes (21) in the base (2). After the L-shaped legs (11) are inserted into the corresponding holes (21) of the base (2), it is noted that the mounting plate (1) is not mated with the base (2) yet. Relative movement of the mounting plate (1) to the base (2) allows each L-shaped leg (11) to engage with a periphery defining the corresponding hole (21) in the base (2) such that the mounting plate (1) is engaged with the base (2).

After the relative movement between the mounting plate (1) and the base (2), the first hole (121) of the first ear (12) of the mounting plate (1) communicates with the second hole (221) of the second ear (22) of the base (2). Thereafter screws (5) are employed into the mated first and second holes (121,221) to securely engage the mounting plate (1) with the base (2) such that relative position between the mounting plate (1) and the base (2) is secured.

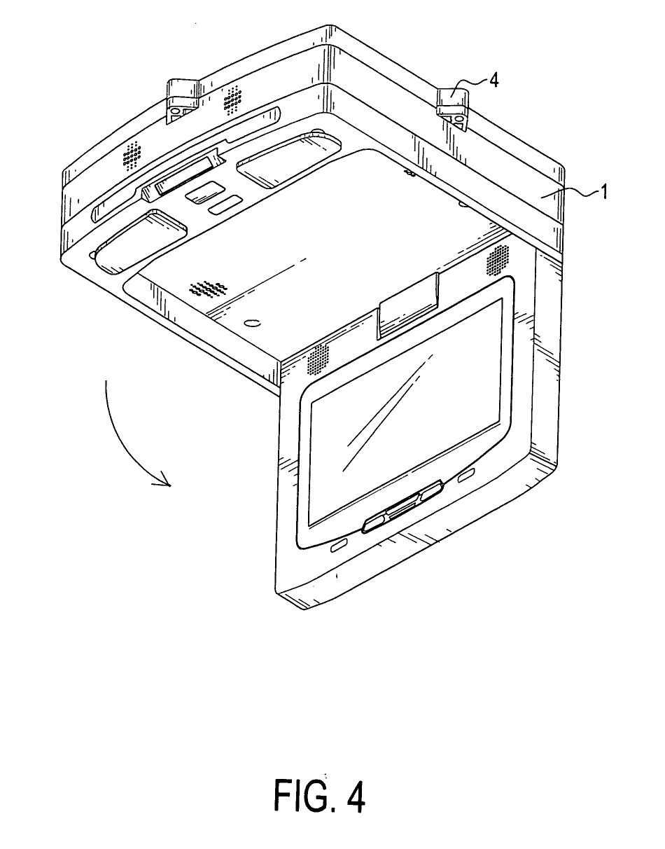

With reference to FIG. 4, it is noted that after the locking device of the present invention is assembled onto the vehicle ceiling (4), the movie player (not numbered) is able to be lowered to allow a viewer to easily watch a program. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A locking device for a ceiling mounted movie player, the locking device comprising:
a mounting plate for pivotally receiving therein a movie player, the mounting plate having multiple pairs of L-shaped legs oppositely formed on opposite sides of a face of the mounting plate and first ears each formed on a peripheral side face of the mounting plate and having a first hole defined through the first ear;
a base adapted to be securely engaged with a vehicle ceiling, the base having multiple pairs of holes defined to correspond to the L-shaped legs so that the L-shaped legs are able to be inserted into the holes to secure engagement between the mounting plate and the base, the base further having second ears each formed on a peripheral side face of the base and having a second hole defined through the second ear to correspond to and mate with the first hole of the first ear such that after the L-shaped legs are inserted into the holes of the base, relative movement of the mounting plate to the base allows the mounting plate to securely engage with the base and thus screws are able to be extended through the mated first and second holes of the mounting plate and the base to fix relative position between the mounting plate and the base.
